(19) United States
(12) Patent Application Publication
(10) Pub. No.: US 2021/0059791 A1
(43) Pub. Date: Mar. 4, 2021

(54) DENTAL IMPLANT FIXTURE

(71) Applicant: Taekyoung LEE, Seoul (KR)

(72) Inventor: Taekyoung LEE, Seoul (KR)

(21) Appl. No.: 16/971,329

(22) PCT Filed: Feb. 20, 2019
(86) PCT No.: PCT/KR2019/002042

§ 371 Date: Aug. 20, 2020

(30) Foreign Application Priority Data
Feb. 21, 2018 (KR) 10-2018-0020336

(51) Int. Cl. A61C 8/00

(52) U.S. Cl. CPC A61C 8/0024

(57) ABSTRACT

A dental implant fixture is proposed. The dental implant fixture is configured to be implanted in a straight alveolar bone perforation hole without inclination, and includes: a head to which an abutment is coupled; a self-tapping portion extending from the head and having a ridge diameter of cutting blades that is larger than an inner diameter of the alveolar bone perforation hole; and a guide extending from the self-tapping portion and having a diameter corresponding to the inner diameter of the alveolar bone perforation hole.

### TECHNICAL FIELD

The present invention relates to a dental implant fixture and, more particularly, to an implant fixture having a new structure that is firmly implanted in the alveolar bone without a gap and then induces good osseointegration, thereby being able to secure the function of an artificial tooth for a long period of time.

### TECHNICAL BACKGROUND

A dental implant (hereafter, briefly referred to as an “implant”) is also called an artificial tooth or a third tooth. That is, an implant means a dental treatment that restores the function of a natural tooth by implanting an artificial tooth, which is made of a material having excellent biological adaptability such as titanium-based metal, in the jawbone at the portion with a tooth missing or a tooth pulled out, or means an artificial tooth itself. When the jawbone is insufficient at the place where an implant will be implanted, the implant is implanted, in some cases, after the volume of bone tissues is increased to be able to sufficiently surround the implant through additional surgeries such as a bone graft and distraction osteogenesis.

Such implants have various structures, and, as can be seen from several disclosed documents, are fundamentally composed of a fixture, an abutment, and an artificial crown. The fixture is made of a material having excellent biological adaptability in a screw shape, is embedded in the alveolar bone without a tooth, and is osseo-integrated with the bone with a tooth missing. The abutment, which is an upper structure on which the artificial crown for mastication and beauty treatment is mounted, is thread-fastened to the fixture disposed thereunder.

As described above, an implant is structurally and functionally composed of about three parts. In particular, success of implanting depends on how firmly a fixture is implanted in the alveolar bone without a gap as planned, whether good osseointegration is induced on the surface of the fixture, and whether a coupling force similar to a natural tooth can be achieved. In other words, it is possible to secure the function as an artificial tooth for a long period of time only when a fixture that is the base of an implant is firmly implanted in the alveolar bone.

Unstable fixing of a fixture usually occurs when the space between the fixture and the alveolar bone is large. When the space is large, inflammation tissues or soft tissues grow faster than the tissues of the alveolar bone, so soft tissues, inflammation tissues, or bacteria stick first to and grow on the surface of the fixture before osseointegration is progressed by growth of osteocytes. Accordingly, the implant may be naturally pulled out or need to be forcibly removed, and if severe, re-implanting may be impossible. Considering that implanting is expensive, it is not too much to emphasize that a fixture should be firmly implanted in an alveolar bone.

Further, a fixture should be positioned biologically safely with respect to anatomic structures such as the neural tubes close to the alveolar bone or the maxillay sinus and should be positioned such that the thickness of the surrounding alveolar bone is sufficient. An artificial bone transplantation surgery that is performed for an insufficient thickness of the alveolar bone should be performed at a biomechanically good position for the alveolar bone and a fixture, and to this end, a precise guide surgery (guide surgery) is applied and the ratio of application thereof increases. A drill that is used for a precise guide surgery has cutting blades corresponding to the shape of a fixture, and when a fixture has a tapered shape, the function of inducing the cutting direction has to depend on a separate guide due to the tapered shape of the cutting blade corresponding to the fixture, so the guide precision is relatively low in the cutting process. Accordingly, when a tapered drill is used, the possibility of a fixture being implanted at a position that is not safe or is not physiologically excellent is high, which results in failure of implant. For this reason, it is preferable to use a straight drill having a high guide ability, and in addition, it is required to change and improve the shape of fixtures to correspond to the straight shape.

For this reason, an effort to improve a fixture fundamentally having a simple structure with threads on a cylindrical body has been made, and according to the present invention, an improved implant fixture from which a best implant result can be expected was achieved on the basis of clinical experiences over several years.

### DETAILED DESCRIPTION

### Problems to be Solved

An objective of the present invention is to provide a dental implant fixture having a new structure that simplifies a hole, which is formed in the alveolar bone, in a straight shape, is firmly implanted in a jawbone without inclination and shaking of the implant fixture, and induces good osseointegration, thereby being able to secure the function of an artificial tooth for a long period of time.

### Solution to Solve the Problem

The present invention relates to a dental implant fixture that is implanted in a straight alveolar bone perforation hole without inclination, the dental implant fixture including: a head to which an abutment is coupled; a self-tapping portion extending from the head and having a ridge diameter of cutting blades that is larger than an inner diameter of the alveolar bone perforation hole; and a guide extending from the self-tapping portion and having a diameter corresponding to the inner diameter of the alveolar bone perforation hole.

The head may have a flat portion that is disposed close to the self-tapping portion and is a flat surface.

A minor diameter of the cutting blades of the self-tapping portion may correspond to the inner diameter of the alveolar bone perforation hole.

A depth of at least one or more taps formed across the cutting blades may correspond to the minor diameter of the cutting blades.

According to an embodiment of the present invention, at least one or more tangential grooves may be circumferentially formed or at least one or more axial grooves may be longitudinally formed on the guide.

At least one or more tangential grooves may be circumferentially formed and at least one or more axial grooves may be longitudinally formed on the guide.

Depths of the tangential grooves and the axial grooves formed on the guide may be the same.

According to another embodiment of the present invention, the alveolar bone perforation hole may be a multi-stage hole having a small hole inside and a large hole outside, and the guide may be a multi-stage guide having a first guide and a second guide that have diameters respectively corresponding to inner diameters of the small hole and the large hole.

A length of the first guide may correspond to a depth of the small hole and, depending on embodiments, the length of the first guide may be an integer time of a gap between straight drills making a set.

The second guide may have at least one or more of at least one of a tangential groove circumferentially formed and an axial groove longitudinally formed.

According to an embodiment of the present invention, a cavity having an open top may be formed in the head and a tool coupling groove may be formed on an inner surface of the cavity.

An upper ridge having a circular protrusive edge protruding from an outer surface of the head may be formed at an upper end of the head.

A spherical or conical narrowed portion may be formed at a distal end of the guide.

The cutting blades of the self-tapping portion may be formed in multiple spirals and start points of the multiple spiral cutting blades may be circumferentially uniformly distributed.

### Advantages of Invention

The dental implant fixture of the present invention having the configuration described above is accurately and firmly implanted through the guiding operation by a guide having an outer diameter corresponding to a cylindrical alveolar bone perforation hole, which is accurately formed by a precision guide surgery, and a self-thread forming operation of a self-tapping portion.

Further, the head is made flat in consideration of the average bone loss amount of the upper alveolar bone after an implant is implanted, whereby it is possible to treat periodontitis around an implant and wash the implant.

Further, since grooves are longitudinally and/or circumferentially formed on the guide, it is possible to reduce friction when implanting the fixture in a perforation hole accurately formed with a very small tolerance by a precise guide implant surgery (guide surgery), it is possible to increase osseointegration between the fixture and the alveolar bone by increasing the surface area after the fixture is implanted, and it is possible to prevent the implant from turning, being shaken up and down, or being pulled out after osseointegration.

Further, since the end of the guide is a multi-stage guide smaller than the minor diagram of the self-tapping portion or the outer diameter of the second guide, it is possible to prevent the fixture (in more detail, the guide) from being exposed out of the alveolar bone or from going over neural tubes or the side of the maxillay sinus.

Further, since the dental implant fixture of the present invention has an upper ridge having a circular protrusive edge protruding from the outer surface of the head is formed at an upper end of the head, it is possible to increase sealability for preventing soft tissues or inflammation tissues from growing into the gap between an implant and a perforation hole HL in the early stage of implantation of the implant and it is possible to prevent the implant from being implanted deeper than the plan due to the self-thread forming function of the self-tapping portion.

### BRIEF DESCRIPTION OF DRAWINGS

FIG. 1 is a perspective view showing a first embodiment of a dental implant fixture according to the present invention.

FIG. 2 is a cross-sectional view taken along line A-A in FIG. 1.

FIG. 3 is a view showing the state in which the implant fixture of FIG. 1 is implanted in an alveolar bone perforation.

FIG. 4 is a view showing an example in which a tap groove is spirally formed in the embodiment of FIG. 1.

FIGS. 5a and 5b are views showing an example in which cutting blades of a self-tapping portion are formed in double spirals and triple spirals in the first embodiment of FIG. 1.

FIGS. 6 to 8 are perspective views showing a second embodiment of a dental implant fixture according to the present invention.

FIG. 9 is a view showing the state in which the implant fixture of FIG. 8 is implanted in an alveolar bone perforation.

FIGS. 10 and 11 are perspective views showing a third embodiment of a dental implant fixture according to the present invention.

FIG. 12 is a view showing the state in which the implant fixture of FIG. 9 is implanted in an alveolar bone perforation.

### EMBODIMENTS

When a term such as “on” or “over” indicates a layer, a region, a pattern, or structures in this specification, it should be understood that the layer, region, pattern, or structures may be positioned right over another layer, region, pattern, or structure or interposed layer, region, pattern, or structures may exist. When a term such as “under” or “below” indicates a layer, a region, a pattern, or structures in this specification, it should be understood that the layer, region, pattern, or structures may be positioned right under another layer, region, pattern, or structure or interposed layer, region, pattern, or structures may exist. Terms “include” and “including” are equal to terms “has” and “having” respectively.

Further, terms such as “first” and “second” (e.g., first and second portions) are used to discriminate one or more specific features unless stated differently in detail in the specification. This state about “first” does not necessarily suggest two or more. The statement is not intended to designate a time sequence, structural directions, or left and right directions (for example, a left side and a right side) for specific features unless clearly stated. Further, the terms “first” and “second” may be used selectively or compatibly for members.

Further, “exemplary” means not “best”, but an “example”. It should also be understood that features, layers, and/or members in this specification in which they are described and shown with specific sizes and/or directions with respect to each other are intended for simple and easy understanding and the actual sizes and/or directions may be considerably different from the examples. That is, the sizes of members may be exaggerated to be clearly shown and may be different from the actual sizes of the members. Not all members that should be included in the figures are shown and are limited to this specification, but members other than necessary features of this specification may be added or removed.

In the figures and description of embodiments of the present invention, (in some cases) well-known members are omitted for clarity and may be simplified as members suitable for clearly understanding the present invention. Those skilled in the art may recognize preferable and/or necessary members for achieving the present invention. However, those members are well known to those skilled in the art and do not even help better understand the present invention, so discussion of these members is not provided in this specification.

The same reference numerals are used to designate the same or similar components in the accompanying drawings.

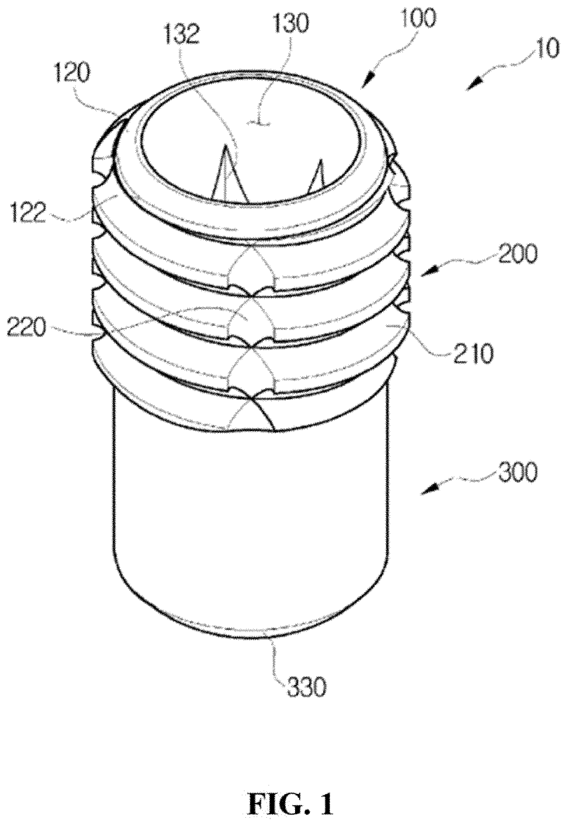

FIG. 1 is a perspective view showing a first embodiment of a dental implant fixture 10 according to the present invention, which shows the most fundamental structure of the implant fixture 10 according to the present invention.

First, the dental implant fixture 10 of the present invention has been designed under the assumption that it is implanted in a straight alveolar bone perforation hole HL (i.e., a smooth cylindrical hole) that is not inclined. The cylindrical perforation hole HL is a hole for implanting a fixture 10 having the most fundamental shape, but recently, there is a tendency that the shape of the perforation hole HL is changed in various ways to increase the coupling strength of the fixture 10. For example, there is a hole tapered such that the diameter decreases toward the inside or a hole that is fundamentally a cylindrical hole, but has a profile widening in the direction of prosthesis with respect to the upper surrounding of an implant.

In spite of this recent tendency, there are many reasons for assuming that the present invention is applied to a straight alveolar bone perforation that is not inclined.

Recently, a precise guide implant surgery that accurately forms a perforation hole HL using an oral fixture such as a mouthpiece, that is, the guide template in Patent Document 2 is spotlighted. A bushing that guides a driving position and driving direction of a drill for forming a hole in the alveolar bone AB and can limit a cutting depth is embedded in the guide template and the bushing guides accurate cutting by the drill, whereby a perforation hole HL is precisely formed, as intended, the success rate of an implant surgery is considerably improved.

However, there is a problem that it is difficult to accurately guide a drill when making the shape of a hole by changing a cylindrical hole. That is, since a tapered drill has an inclined side, the length that can be induced by a cylindrical bushing decreases. Further, in order to provide a profile in which the upper surrounding of an implant widens in the direction of prosthesis, a countersink drill or profile drill is required, but the shapes of these specific drills are also not suitable for guiding a bushing.

Accordingly, the present invention has been designed such that the implant fixture 10 has implantation followability to be accurately implanted in the perforation hole HL under the assumption that the alveolar bone perforation hole HL is first formed straight without inclination so that the function of a guide template for a precise guide implant surgery is fully achieved and the perforation hole HL is accurately formed.

The present invention is described in detail on the basis of pre-understanding of the development concept of the present invention.

Referring to FIG. 1, the dental implant fixture 10 according to the present invention includes a head 100, self-tapping portion 200, and a guide 300.

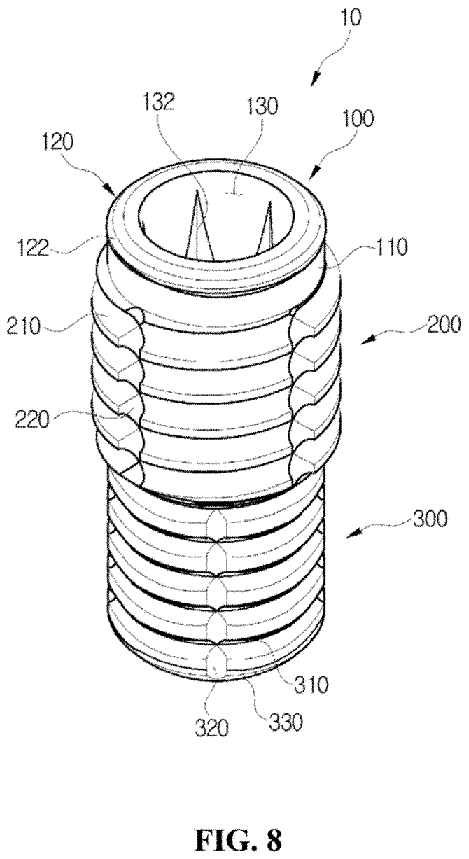

The head 100, which is a portion positioned on the top in FIG. 1, is a portion to which an abutment is coupled. In particular, the head 100 may have a flat portion 110 that is a flat outer surface and is disposed close to the self-tapping portion 200 (see FIG. 8). The flat outer surface means an outer surface having no thread or no prominence-depression structure such as cutting blades 210 or grooves, wherein the cutting blades 210 will be described later herein. It should be understood that a micro-scale fine irregular home structure that is formed by Sandblast, Large-grit, Acid-etched (SLA) surface treatment that is usually applied to implant fixtures is included in the flat outer surface stated in the present invention.

In the dental implant fixture 10 of the present invention, the reason that the structure of the flat portion 110 that is a flat outer surface is included in the head 100 is for coping with a clinical result that average 0.8 mm of an upper alveolar bone AB is usually lost after an implant is implanted. That is, periodontitis may be generated even around an implant. However, when a surgery for removing inflammation in the gum is performed to treat periodontitis, if the alveolar bone AB around the upper portion of the implant melts and a prominence-depression structure (spirals) is exposed, it is difficult to operate instruments for removing the inflammation in the surrounding portion due to the prominence-depression structure and it is difficult to keep the surface of the implant clean using instruments for treating periodontitis or a laser. Accordingly, the flat portion 110 that is a flat outer surface is disposed right over the self-tapping portion 200. The height of the head 100 having the flat portion 110 may be within the range of 0.5˜1.5 mm in consideration of the average bone loss amount.

The self-tapping portion 200 is a portion directly extending from the head 100, in which the ridge diameter (nominal diameter ND) of the cutting blades 210 is larger than the inner diameter of the alveolar bone perforation. It may be noted from the wording that the term “self-tapping portion 200” has a function in that the cutting blades 210 are thread-fastened while forming ridges by themselves when the fixture 10 is implanted into the perforation hole HL (self-thread forming function).

The reason that the self-tapping portion 200 is included in the dental implant fixture 10 of the present invention is also because a precise guide implant surgery is considered. When a fixture without the self-thread forming function is used, it is required to form threads on the inner surface of the perforation hole HL using a tapping drill, but the tapping drill also has an embossed shape, so there is a problem that guide precision by a guide template is deteriorated. Further, when tapping is performed without precise guide, the possibility of changing the path of the previously formed perforation hole HL increases.

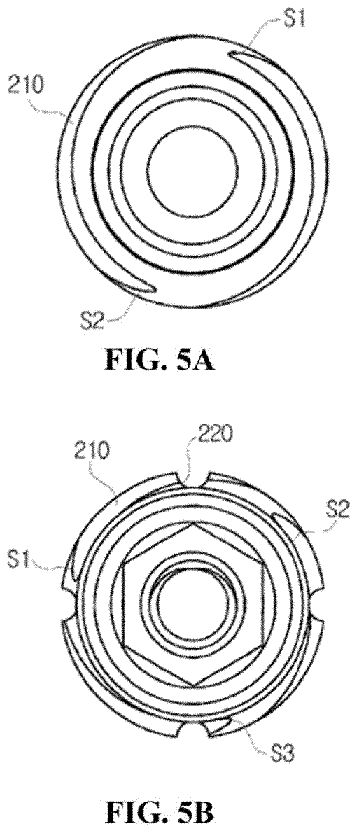

The length of the self-tapping portion 200 may be 3˜5 mm, the height of the cutting blades 210 (a protrusive height with respect to the inner diameter of the alveolar bone perforation) may be appropriately 0.2˜0.5 mm, and the pitch of the cutting blades 210 may be appropriately within the range of 0.5˜3 mm. Further, although the cutting blades 210 are formed in one line in the fixture 10 of FIG. 1, the cutting blades may be formed in multiple spirals such as two lines or three lines, as shown in FIGS. 5a and 5b. That is, FIG. 5a shows an example in which the cutting blades 210 are formed in double spirals and FIG. 5b shows an example in which the cutting blades 210 are formed in triple spirals, in which one important thing is that the start points of the multiple spirals S1, S2, and S3 are uniformly disposed on the circumference. Two start points S1 and S2 are uniformly disposed with a gap of 180 in the double spirals shown in FIG. 5a, and three start points S1, S2, and S3 are uniformly disposed with gaps of 120 in the triple spirals shown in FIG. 5b. When the cutting blades 210 are formed in multiple spirals with uniformly disposed start points, cutting load is uniformly distributed when the self-tapping portion 200 is coupled while forming spirals in the perforation hole HL, so it is possible to obtain the effect that the implantation followability of the fixture 10 is improved.

The guide 300, which is a lower structure extending from the self-tapping portion 200, has a diameter corresponding to the inner diameter of the alveolar bone perforation hole HL. The guide 300 according to the first embodiment of the present invention has a smooth outer surface.

The guide 300 is a portion that guides the dental implant fixture 10 to be precisely guided along the alveolar bone perforation hole HL and accurately implanted, as intended. That is, the guide 300 is first inserted into the perforation hole HL when the dental implant fixture 10 of the present invention is implanted, and the outer diameter of the guide 300 correspond to the inner diameter of the alveolar bone perforation hole HL, so the self-tapping portion 200 starts the self-thread forming when the guide 300 has a length of about 3˜7 mm is sufficiently inserted in and is in close contact with the alveolar bone perforation hole HL. Accordingly, the dental implant fixture 10 of the present invention is accurately guided and implanted without inclination. That is, the guide 300 plays an important role securing that the dental implant fixture 10 is implanted in the perforation hole HL while keeping sufficient implantation follwability even if the dental implant fixture 10 itself has the tapping function.

Further, the guide 300 plays a very important role in terms of the histological analysis of the alveolar bone AB.

In the alveolar bone AB in which an implant is fixed, the outer portion is a cortical bone that has a thickness of 1˜4 mm and has a dense and hard tissue, and a cancellous bone therein is relatively less dense and is weak. Accordingly, even though the perforation hole HL is accurately formed, the internal bone may be easily changed in shape by the force applied by an implant fixture that is implanted, and as a result, the fixture may be biased and fixed in the perforation hole HL.

Further, according to recent research results, in order to reduce the treatment period of implant, sufficient calcification is also good, but it is also recommended to implant an implant in an appropriately calcified alveolar bone AB. This is because the alveolar bone AB keeps the shape well when there is appropriate stimulus. Accordingly, even if the degrees of calcification of patients are different, it is important to manufacture an implant that can be implanted even in a relatively less dense alveolar bone AB in terms of the functional objective of the implant.

In this respect, the feature that the dental implant fixture 10 of the present invention has the guide 300 contributes to achieving accurate guide implantation by applying appropriate stimulus without the guide 300, which has an outer diameter corresponding to the inner diameter of the perforation hole HL, changing the hole even for patients who have different degrees of calcification and less density of tissues.

It should be understood that the fact that the outer diameter of the guide 300 corresponds to the inner diameter of the alveolar bone perforation hole HL includes not only the state in which the diameters are the same, but also a fine minus tolerance is given to the outer diameter of the guide 300 to exclude an excessive force during insertion.

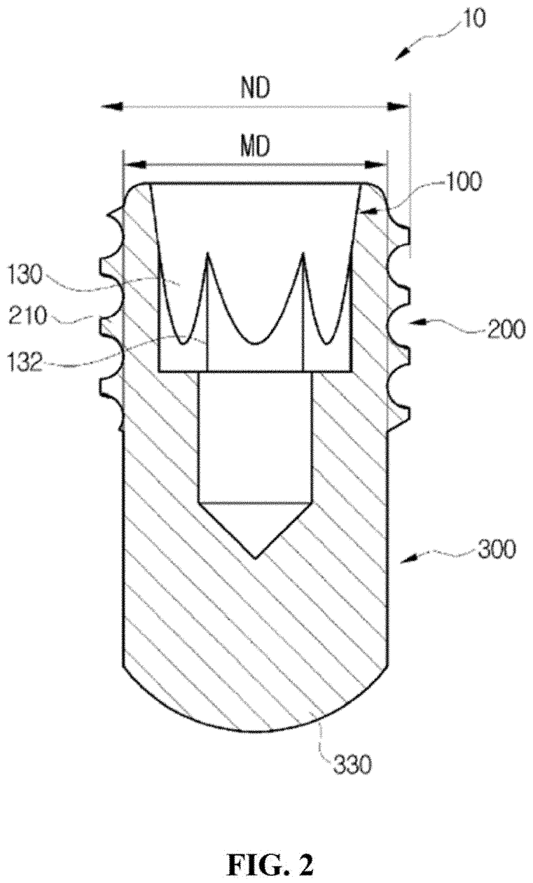

Further, referring to the sectional view of FIG. 2, the minor diameter MD of the cutting blades 210 of the self-tapping portion 200 corresponds to the inner diameter of the alveolar bone perforation hole HL, that is, the outer diameter of the guide 300. This is for making the self-tapping portion 200 performs the self-thread forming on the perforation hole HL and making a least the grooves of the blades 210 come in contact with the surface of the perforation hole HL, thereby keeping the guide function of the guide 300 at the self-tapping portion 200.

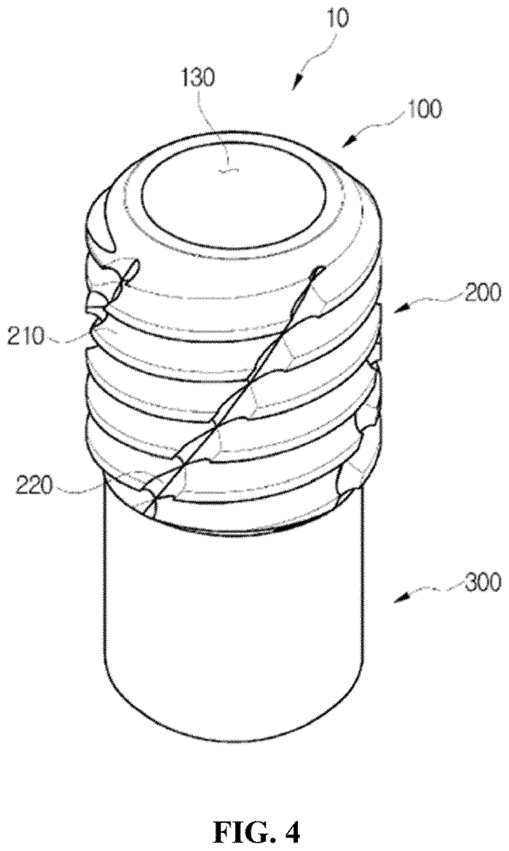

Further, at least one tap groove 220 for discharging cut chips (bone fragments) and supplying washing water is formed across the blades 210 of the self-tapping portion 200 and the depth of the tap groove 220 is also made to correspond to the minor diameter MD of the cutting blades 210, thereby being able to improve the guide function. Further, the tap groove 220 may be formed straight in the longitudinal direction of the self-tapping portion 200, as shown in FIG. 1, or may be spirally formed, as shown in FIG. 4.

Further, other configuration of the first embodiment of the present invention is described hereafter with reference to FIGS. 1 and 2.

The head 100 has a cavity 130 therein, the cavity 130 being open at a top thereof. The cavity 130 provides a space in which the abutment is fitted and coupled. Since it is preferable that the head 100 has a flat outer surface to treat periodontitis and wash an implant in the present invention, the way of forcibly fitting the abutment into the cavity 130 is selected. Further, a tool coupling groove 132 is formed on the inner surface of the cavity 130 so that torque can be applied even without scratching or deforming the outer surface of the dental implant fixture 10. The shape of the cross-section of the cavity 130 (cross-section perpendicular to the longitudinal direction) may be a circle or a polygon (e.g., a hexagon).

Further, an upper ridge 120 having a circular protrusive edge 122 protruding from the outer surface of the head 100 is formed at the upper end of the head 100. The protrusive edge 122 of the upper ridge 120 is finely formed with a height of 0.01˜0.1 mm. The protrusive edge 122 increases sealability for preventing soft tissues or inflammation tissues from growing into the gap between an implant and the perforation hole HL in the early stage of implantation of the implant and prevents the implant from being implanted deeper than the plan due to the self-thread forming function of the self-tapping portion 200. In particular, a “coaxial incision implant surgery” that is one of the advantages of the precise guide surgery is a surgery that does not implant an implant while looking at the alveolar bone AB after cutting a gum, but implants an implant after minimally cutting a gum in coaxial circular shapes with diameters similar to the diameter of the implant. This surgery has an advantage that since the gum is minimally cut, hemorrhage is small and recovery is fast, but has a defect that it is difficult to determine whether an implant has been fixed at a desired depth in the alveolar bone AB. Accordingly, when the upper ridge 120 is positioned at the boundary between an implant and the alveolar bone AB, it is possible to feel that the upper ridge 120 is in contact with the alveolar bone AB (a large increase of load), so it is possible implant the implant at a planned depth while preventing the implant from being implanted deeper than the plan.

Further, a spherical or conical narrowed portion 330 may be formed at the distal end of the guide 300. The narrowed portion 330 is a portion having a diameter that is smaller than the minor diameter MD of the self-tapping portion 200 or the outer diameter of the guide 300 to prevent the guide 300 of the fixture 10 from being exposed out of the alveolar bone AB or from going over neural tubes or the side of the maxillay sinus.

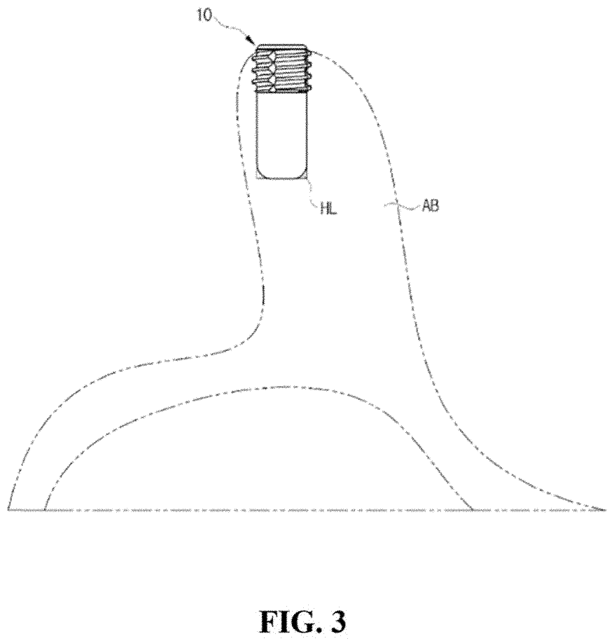

FIG. 3 is a view showing the state in which the dental implant fixture 10 of FIGS. 1 and 2 has been implanted in the alveolar bone perforation hole HL, in which the implant fixture 10 is accurately guided by the guide 300 and is firmly coupled in the alveolar bone AB by the self-thread forming operation of the self-tapping portion 200.

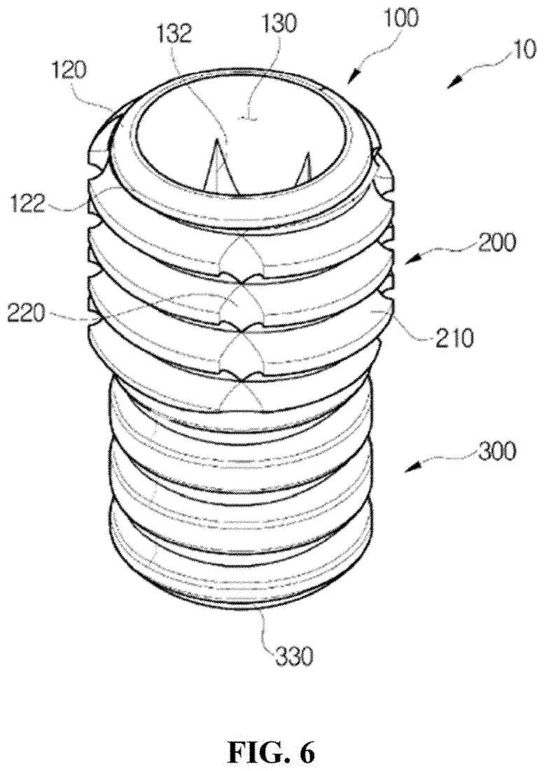

FIGS. 6 to 8 are perspective views showing a second embodiment of the dental implant fixture according to the present invention.

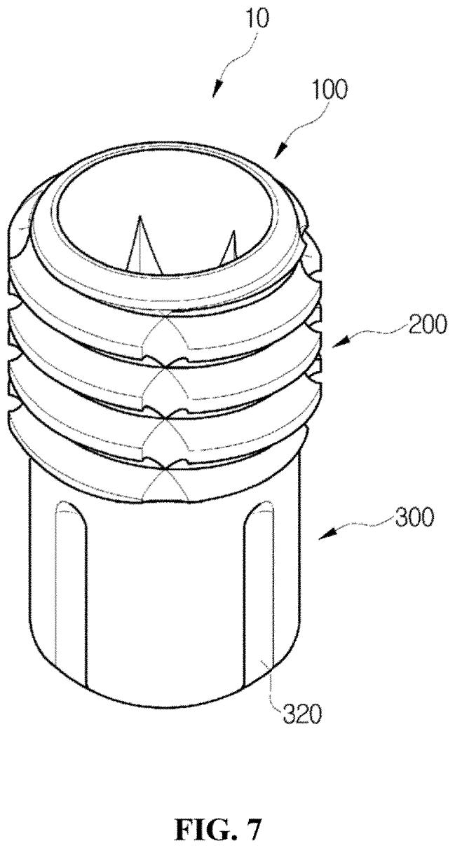

The second embodiment of the present invention is the same as the first embodiment except that grooves are formed on the guide 300. That is, FIG. 6 is an embodiment in which at least one or more tangential grooves 310 are circumferentially formed on the guide 300, FIG. 7 is an embodiment in which at least one or more axial grooves 320 are longitudinally formed on the guide 300, and FIG. 8 is an embodiment in which the tangential grooves 310 and the axial grooves 320 are both formed.

It is the same in the second embodiment of the present invention that the outermost diameter of the guide 300 corresponds to the inner diameter of the perforation hole HL. Accordingly, even though the tangential grooves 310 and/or the axial grooves 320 are formed on the guide 300, there is no self-thread forming function or thread-fastening by the self-tapping portion 200.

The tangential grooves 310 and the axial grooves 320 are provided to reduce friction when the fixture 10 is implanted into the perforation hole HL, which is accurately formed with a very small tolerance by the precise guide surgery, increase osseointegration between the fixture 10 and the alveolar bone AB by increasing the surface area of the guide 300 after the fixture 10 is implanted, prevent the implant from turning after osseointegration (axial grooves), and prevent the implant from being shaken or pulled out (tangential grooves).

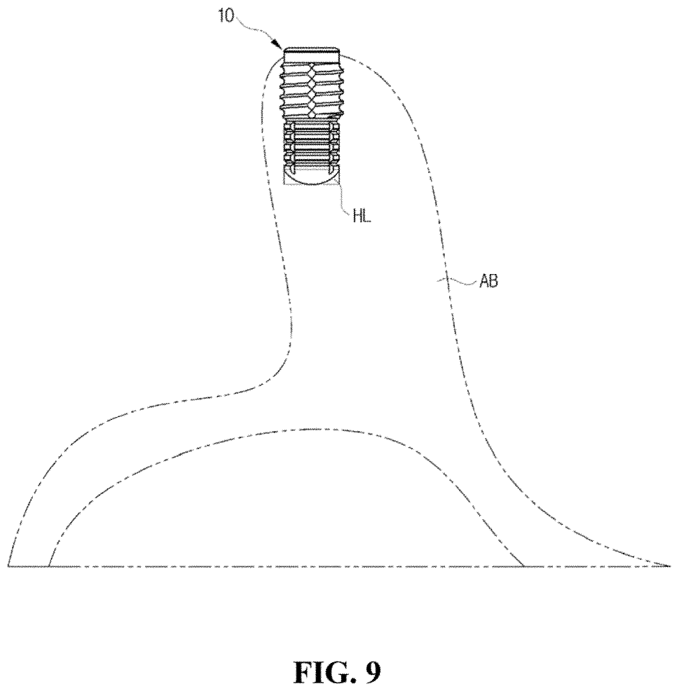

The tangential grooves 310 and the axial grooves 320 may be formed with the same depth on the guide 300. FIG. 9 shows the state in which the dental implant fixture 10 of FIG. 8 having both of the tangential grooves 310 and the axial grooves 320 of the second embodiment of the present invention has been implanted in the alveolar bone AB.

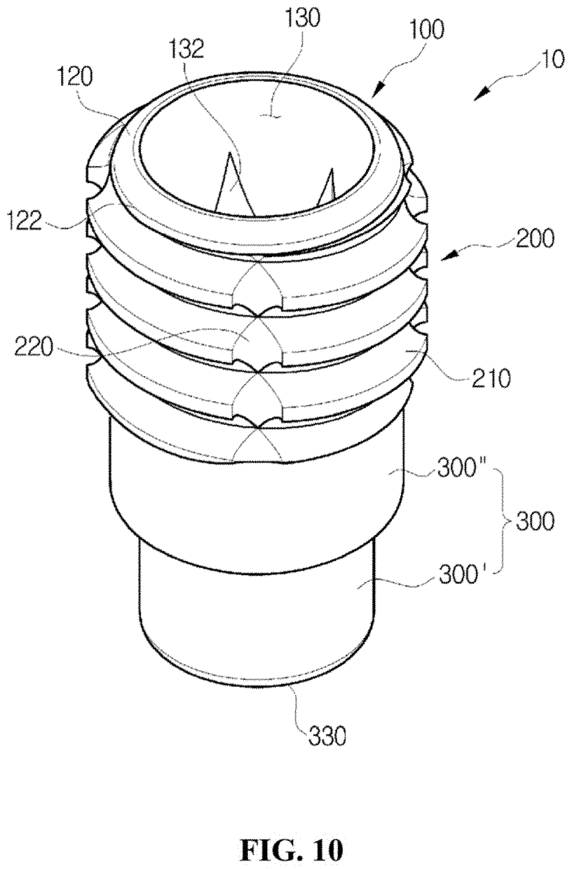

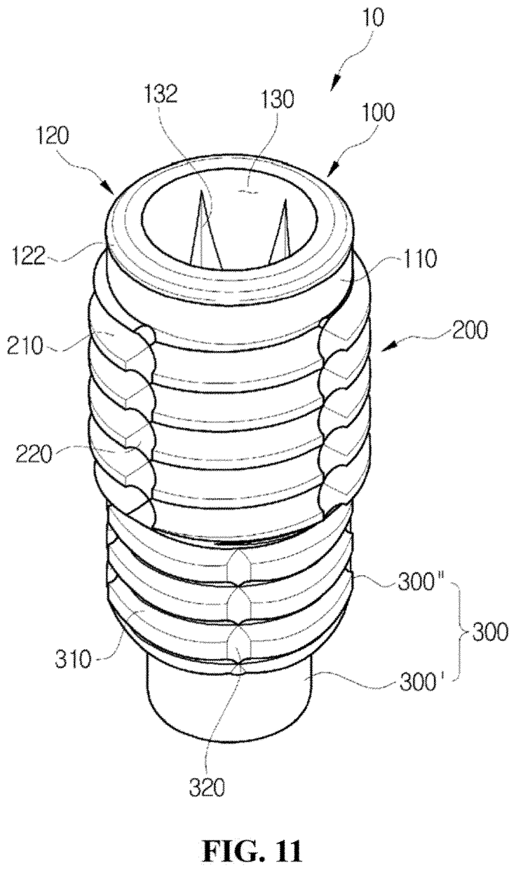

FIGS. 10 and 11 are perspective views showing a third embodiment of the dental implant fixture 10 according to the present invention. In more detail, FIGS. 10 and 11 shows an example in which the third embodiment has been applied to the first embodiment and the second embodiment described above, respectively.

In the third embodiment of the present invention, the guide 300 is a multi-stage guide. That is, the alveolar bone perforation hole HL has multiple holes of a small hole SH inside and a large hole LH outside. Further, the guide 300 is a multi-stage guide having a first guide 300′ and a second guide 300″ that have diameters respectively corresponding to the inner diameters of the small hole SH and the large hole LH of the alveolar bone perforation hole HL. Obviously, if necessary, multiple stages including three or more stages may be implemented, though not shown in the figures, but which actually would not have large usability.

The first guide 300′ that has a small diameter, in more detail, that is smaller than the minor diameter MD of the self-tapping portion 200 or the outer diameter of the second guide 300″ is formed at the end of the guide 300 because of the same reason as the narrowed portion 330 described above. That is, the diameter of the first guide 300′ is reduced to prevent the fixture 10 from being exposed out of the alveolar bone AB or from going over neural tubes or the side of the maxillay sinus, and this avoidance function is further secured when both of the narrowed portion 330 and the first guide 300′ are applied.

The length of the first guide 300′ may correspond to the depth of the small hole SH of the perforation hole HL. The length of the first guide 300′ may be standardized as an integer time of the gap between straight drills making a set. When a perforation hole HL is formed in the alveolar bone AB, generally, a small hole is formed first using a drill having a small diameter (a straight drill without a taper in the present invention, hereafter the same) and then a desired final perforation hole HL is completed using one or more kinds of drills having larger diameters. Accordingly, several drills for perforating the alveolar bone AB are configured as one set. The smaller the diameter of a drill, the smaller the length, and the length gaps between drills in a set have been almost standardized as 2 mm or 1.5 mm all over the world. Accordingly, when the length of the first guide 300′ that corresponds to the depth difference between the small hole SH and the large hole LH is made as an integer time of the gap between straight drills of one set, that is, an integer time of 2 mm or 1.5 mm, the multi-stage guide 300 is accurately fitted to the perforation hole HL without additionally changing the perforation hole HL.

Further, at least one or more of at least one of the tangential groove 310 circumferentially formed and the axial groove 320 longitudinally formed may be formed on the second guide 300″ having a larger outer diameter. It may be considered to form the tangential grooves 310 and/or the axial grooves 320 on the first guide 300′, but the usability would not be that much large because the function of the first guide 300′ is to prevent unnecessary invasion into the oral tissues.

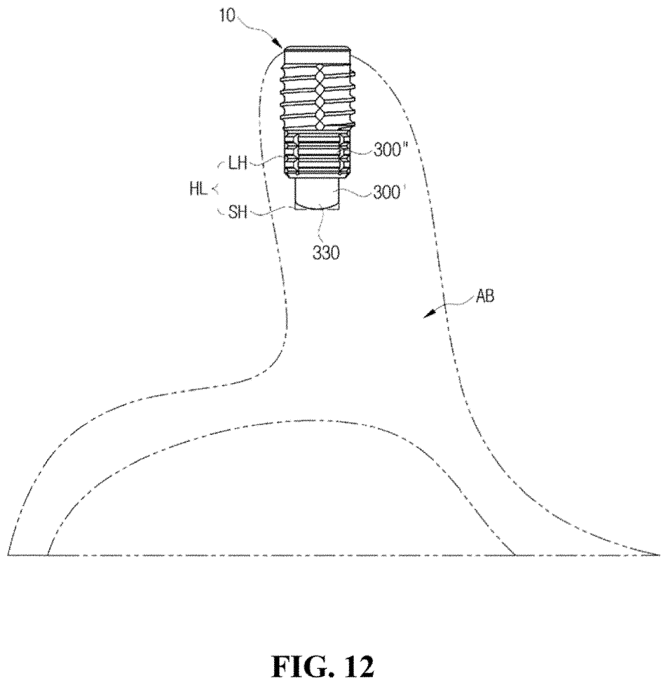

FIG. 12 shows the state in which the dental implant fixture 10 of FIG. 11 that have both of the tangential grooves 310 and/or the axial grooves 320 on the second guide 300″ of the third embodiment has been implanted in the alveolar bone AB.

Examples and embodiments described herein are only examples, those skilled in the art may propose various changes and modifications in consideration of the examples, and the changes and modifications should be understood as being included in the concept and range of the present invention. Accordingly, the present invention is not intended to be limited to the examples described herein and should be given the largest range corresponding to the principle and new features described herein.

### INDUSTRIAL APPLICABILITY

The present invention can be usefully applied as a dental implant fixture that is implanted in a cylindrical alveolar bone perforation hole.

1. A dental implant fixture that is implanted in a straight alveolar bone perforation hole without inclination, the dental implant fixture comprising:
a head to which an abutment is coupled;
a self-tapping portion extending from the head and having a ridge diameter of cutting blades that is larger than an inner diameter of the alveolar bone perforation hole; and
a guide extending from the self-tapping portion and having a diameter corresponding to the inner diameter of the alveolar bone perforation hole.

2. The dental implant fixture of claim 1, wherein the head comprises a flat portion that is disposed close to the self-tapping portion and is a flat surface.

3. The dental implant fixture of claim 1, wherein a minor diameter of the cutting blades of the self-tapping portion corresponds to the inner diameter of the alveolar bone perforation hole.

4. The dental implant fixture of claim 3, wherein a depth of at least one or more taps formed across the cutting blades corresponds to the minor diameter of the cutting blades.

5. The dental implant fixture of claim 1, wherein at least one or more tangential grooves are circumferentially formed on the guide.

6. The dental implant fixture of claim 1, wherein at least one or more axial grooves are longitudinally formed on the guide.

7. The dental implant fixture of claim 1, wherein at least one or more tangential grooves are circumferentially formed and at least one or more axial grooves are longitudinally formed on the guide.

8. The dental implant fixture of claim 7, wherein depths of the tangential grooves and the axial grooves formed on the guide are the same.

9. The dental implant fixture of claim 1, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

10. The dental implant fixture of claim 9, wherein a length of the first guide corresponds to a depth of the small hole.

11. The dental implant fixture of claim 10, wherein the length of the first guide is an integer time of a gap between straight drills making a set.

12. The dental implant fixture of claim 9, wherein the second guide has at least one or more of at least one of a tangential groove circumferentially formed and an axial groove longitudinally formed.

13. The dental implant fixture of claim 1, wherein a cavity having an open top is formed in the head and a tool coupling groove is formed on an inner surface of the cavity.

14. The dental implant fixture of claim 1, wherein an upper ridge having a circular protrusive edge protruding from an outer surface of the head is formed at an upper end of the head.

15. The dental implant fixture of claim 1, wherein a spherical or conical narrowed portion is formed at a distal end of the guide.

16. The dental implant fixture of claim 1, wherein the cutting blades of the self-tapping portion are formed in multiple spirals and start points of the multiple spiral cutting blades are circumferentially uniformly distributed.

17. The dental implant fixture of claim 2, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

18. The dental implant fixture of claim 3, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

19. The dental implant fixture of claim 4, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

20. The dental implant fixture of claim 5, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

21. The dental implant fixture of claim 6, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

22. The dental implant fixture of claim 7, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.

23. The dental implant fixture of claim 8, wherein the alveolar bone perforation hole is a multi-stage hole having a small hole inside and a large hole outside, and
wherein the guide is a multi-stage guide having a first guide and a second guide that have diameters respectively corresponding to inner diameters of the small hole and the large hole.
